(19) United States
(12) Patent Application Publication
(10) Pub. No.: US 2003/0033907 A1
(43) Pub. Date: Feb. 20, 2003

(54) Safe cork removing device for wine bottles

(76) Inventor: Fen-Lan Lian, Chunghua (TW)

Correspondence Address: Fen-Lan Lian, 235 Chung-Ho Box 8-24, Taipei, TW

(21) Appl. No.: 10/100,297

(22) Filed: Mar. 19, 2002

(30) Foreign Application Priority Data
Aug. 15, 2001 (TW) 90213927

(51) Int. Cl. B67B 7/00

(52) U.S. Cl. 81/3.2

(57) ABSTRACT

A safe cork removing device for wine bottles has a hollow needle head, a refrigerant can container, a sliding block and a seal cover. The sliding block is installed in the refrigerant can container from an opening of refrigerant can container. The limiting rod is exactly positioned in the longitudinal sliding groove of the refrigerant can container. The sliding block is movable along the longitudinal sliding groove by operating the limiting rod. The hollow needle head can be inserted into a cork stopper sealing a wine bottle, and then a refrigerant can is placed in a refrigerant can container. By extruding the refrigerant can, the refrigerant will flow into the wine bottle, and by the pressure of the refrigerant, the cork stopper separates from the wine bottle.

### FIELD OF THE INVENTION

The present invention relates to cork removing devices, and particularly to a safe cork removing device for a wine bottle wherein a hollow needle head is inserted into a cork stopper sealing a wine bottle, and then a refrigerant can is placed in a refrigerant can container. By extruding the refrigerant can, the refrigerant will flow into the wine bottle, and by the pressure of the refrigerant, the cork stopper separates from the wine bottle.

### BACKGROUND OF THE INVENTION

A general corkscrew used for wine bottles is drilled into a cork by human force and then the corkscrew is pulled out manually. However, a large force is necessary to pull out the corkscrew. Moreover, it is possible that the force for holding a wine bottle is unsteady so that the bottle falls down and wine will pour out.

Therefore, a mechanical corkscrew is developed. The mechanical corkscrew has two claws at two sides thereof which clamp and fix the bottle head. Then the corkscrew is drilled into the cork. Then a spanner of the mechanical corkscrew is used to pull out the corkscrew and the cork. However, this mechanical corkscrew has a larger volume and is made of metal. Therefore, it is heavy and complex and has a higher cost. The operation is difficult. Since the cork easily cracks so that the corkscrew can not be pulled out, this prior art is not an ideal product. In another prior art, refrigerant device for pulling a cork is developed. In this prior art, at a lower end of a refrigerant can container is fixed with a hollow needle head. By the user to hold the refrigerant can container, the hollow needle head can be inserted into the cork. Then, a refrigerant can is placed in the refrigerant can container. Then refrigerant in the refrigerant can is compressed and then filled into the bottle through the hollow needle head. By the pressure of the refrigerant, the corkscrew is ejected out. However, since the hollow needle head is always at the bottom of the refrigerant can container, when the user pulls out the hollow needle head for storage, the user is easily hurt by the needle.

### SUMMARY OF THE INVENTION

Accordingly, the primary object of the present invention is to provide a safe cork removing device for a wine bottle, wherein the safe cork removing device for a wine bottle has a hollow needle head, a refrigerant can container, a sliding block and a seal cover. The hollow needle head can be inserted into a cork stopper sealing a wine bottle, and then a refrigerant can is placed in a refrigerant can container. By extruding the refrigerant can, the refrigerant will flow into the wine bottle, by the pressure of the refrigerant, the cork stopper separates from the wine bottle. The refrigerant can container has a longitudinal sliding groove formed at a lateral side thereof. An upper and a lower lateral ends of the longitudinal sliding groove are formed with an upper positioning notch and a lower positioning notch, respectively. The sliding block has a screw hole at a center thereof for locking a hollow needle head. A limiting rod extends from a lateral side of the sliding block. The sliding block is installed in the refrigerant can container from an opening of refrigerant can container. The limiting rod is exactly positioned in the longitudinal sliding groove. The sliding block is movable along the longitudinal sliding groove by operating the limiting rod.

By the upper positioning notch and lower positioning notch at two ends of the longitudinal sliding groove, when the push block is pushed toward one of the positioning notches, the limiting rod will slide into one of the upper and lower positioning notches and then stop therein.

The various objects and advantages of the present invention will be more readily understood from the following detailed description when read in conjunction with the appended drawing.

### BRIEF DESCRIPTION OF THE DRAWINGS

FIG. 1 is an exploded perspective view of the elements of the present invention.

FIG. 2 is an assembled perspective view of the present invention.

FIG. 3A is a cross sectional view showing the storage of the present invention.

FIG. 3B is a cross sectional view showing the hollow needle head is prepared to be inserted into a cork stopper according to the present invention;

FIG. 4A shows one embodiment of the present invention where refrigerant is filled into a bottle.

FIG. 4B is an enlarged partial schematic view showing refrigerant draining hole of the hollow needle head of the present invention.

FIG. 4C shows one embodiment of the present invention in that the cork stopper is separated from the bottle after refrigerant is filled.

FIG. 4D shows one embodiment of the present invention wherein the hollow needle head separates from the cork stopper.

### DETAILED DESCRIPTION OF THE PREFERRED EMBODIMENT

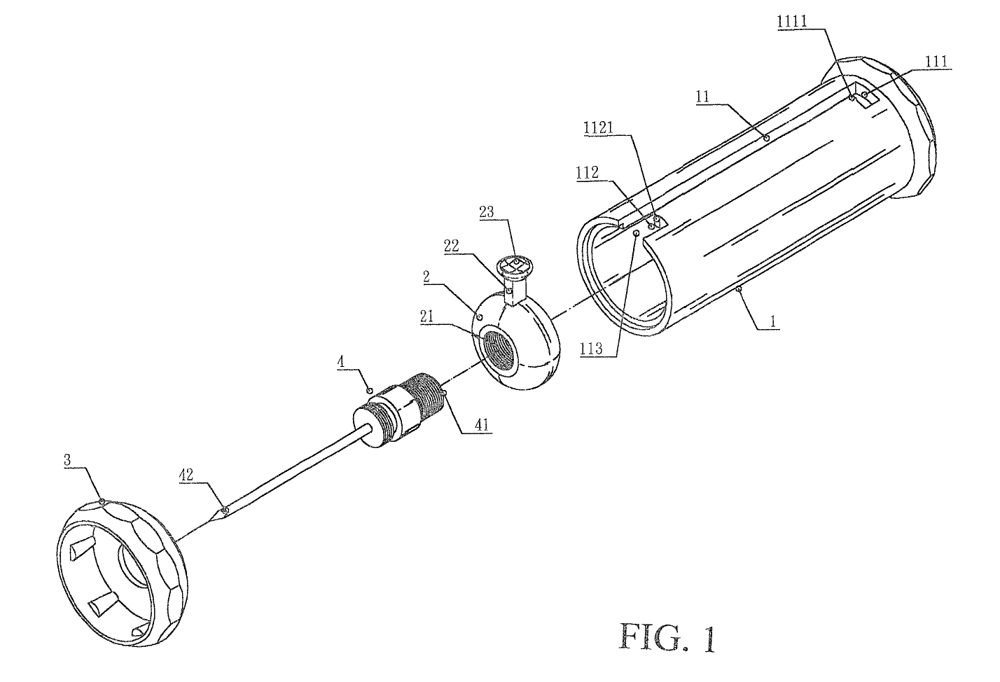

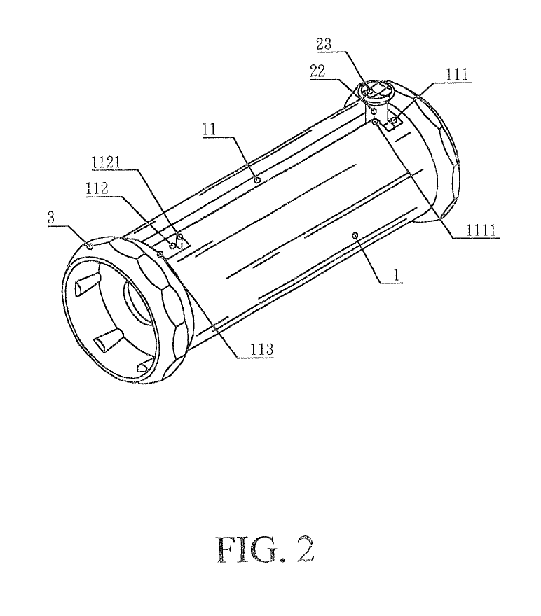

At first, referring to FIGS. 1 and 2, the present invention has the following components.

A refrigerant can container 1 has a longitudinal sliding groove 11 formed at a lateral side thereof. The upper and lower lateral ends of the longitudinal sliding groove 11 are installed with an upper positioning notch 111 and a lower positioning notch 112, respectively. At the connection portion of the upper positioning notch 111 and the longitudinal sliding groove 11 has an upper limiting nose 1111 and at the connection of the lower positioning notch 112 and the longitudinal sliding groove 11 has a lower limiting nose 1121.

A sliding block 2 has a screw hole 21 at a center thereof for locking a hollow needle head 4. A limiting rod 22 extends from a lateral side of the sliding block 2. A push block 23 is formed at an outer end of the limiting rod 22. The sliding block 2 is installed in the refrigerant can container 1 from the opening at the lower end of the refrigerant can container 1. The limiting rod 22 is exactly positioned in the longitudinal sliding groove 11 and the push block 23 is positioned at an outer side of the refrigerant can container 1. The sliding block 2 can move along the longitudinal sliding groove 11 by operating the limiting rod 22. By the upper positioning notch 111 and lower positioning notch 112 at two ends of the longitudinal sliding groove 11, when the push block 23 is pushed toward one of the positioning notches, the limiting rod 22 will press one of the positioning noses 1111, 1121 so as to slide into the positioning notches 111, 112 and then stop therein, thereby, the sliding block 2 being prevented from releasing. At this time, the hollow needle head 4 will move upwards or downwards with the sliding block 2.

A seal cover 3 is used to seal a lower end of the refrigerant can container 1. Then the structure is welded by supersonic welding and the notch 113 of the longitudinal sliding groove 11 is also sealed so that the sliding block 2 will not fall out.

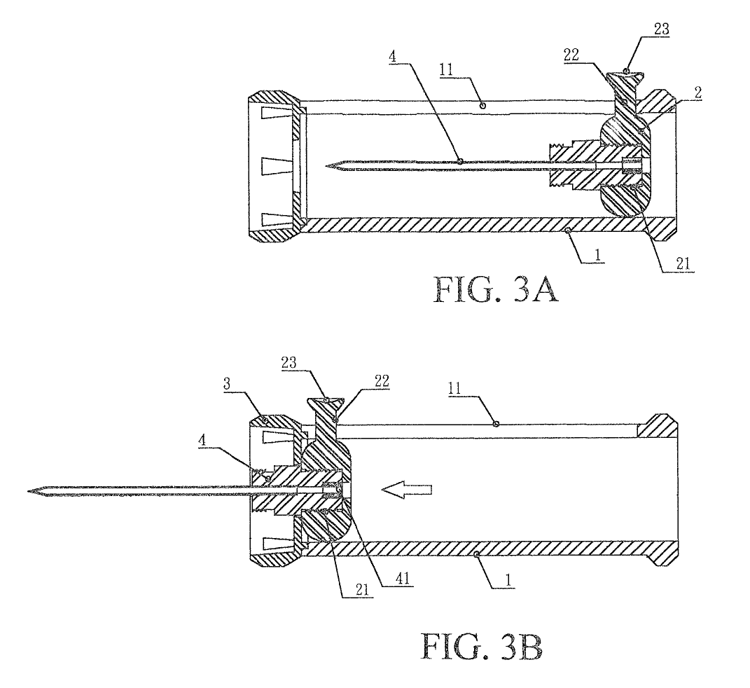

Referring to FIGS. 2, 3A and 3B, when the hollow needle head 4 is driven by the push block 23 and then moves to a lower end of the refrigerant can container 1, the limiting rod 22 of the sliding block 2 will move toward the lower positioning notch 112. The limiting rod 22 presses the lower limiting nose 1121, thereby, the limiting rod 22 being buckled in the lower positioning notch 112. Whereas when the limiting rod 22 separates from the lower positioning notch 112, and then pushes the push block 23 to move upwards. Then the sliding block 2 will move to the topmost. The push block 23 is then pushed toward the upper positioning notch 111. Then the limiting rod 22 will press through the upper limiting nose 1111 to move into the upper positioning notch 111. As a result, the hollow needle head 4 is stored safely.

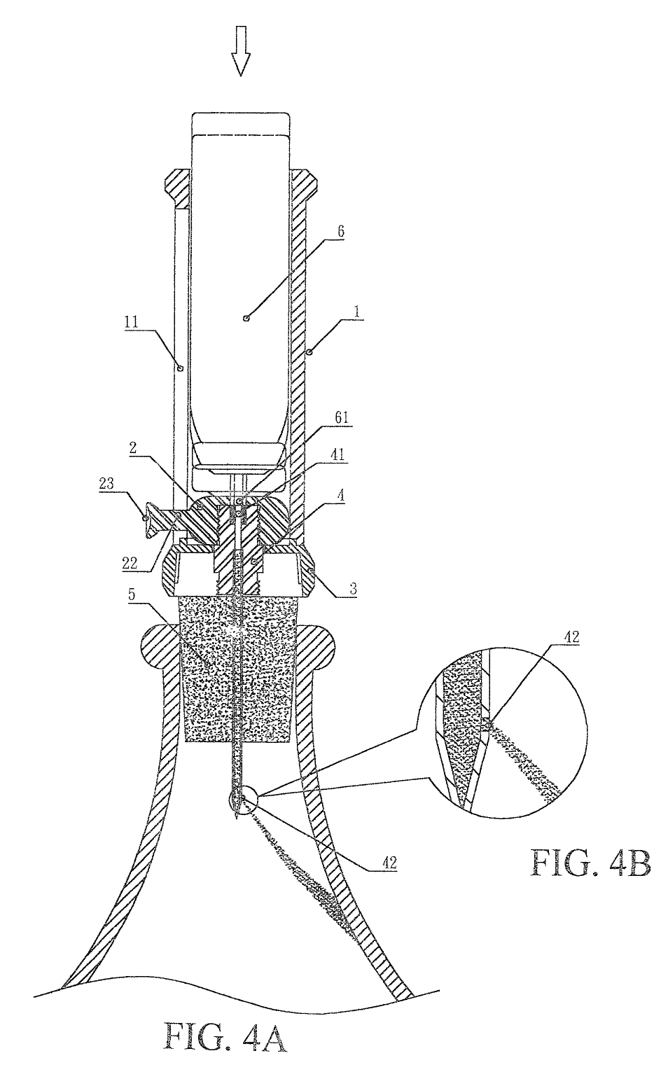

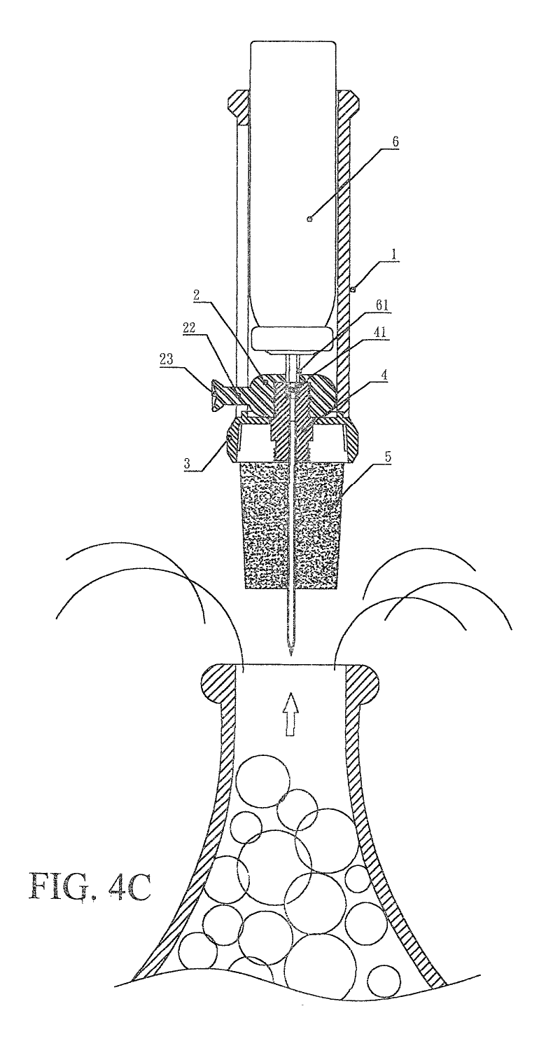

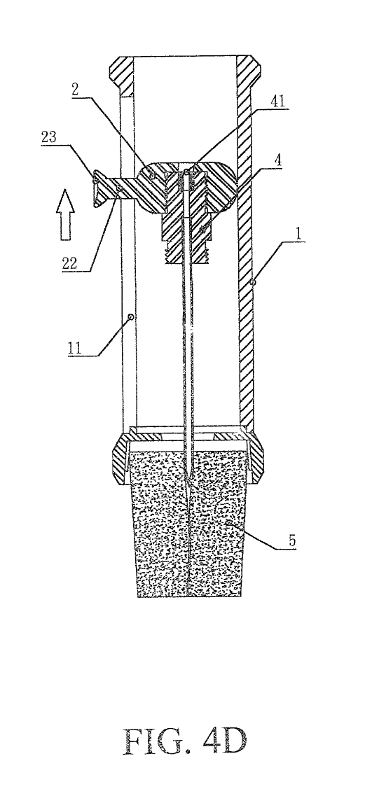

Referring to FIGS. 4A and 4B, when the hollow needle head 4 is pushed out of the refrigerant can container 1, and then penetrates through a cork stopper 5 of a wine bottle. Then a refrigerant can 6 can be placed in the refrigerant can container 1 so that the notch of the refrigerant can 6 is exactly aligned to the filling hole 41 of the refrigerant can container 1. When the refrigerant can 6 is extruded downwards, refrigerant will fill into the bottle from the draining hole 42 of the hollow needle head 4. By the pressure of the refrigerant in the bottle, the cork stopper 5 separates from the wine bottle (referring to FIG. 4C). With reference to FIGS. 2 and 4D, the push block 23 is moved to separate from the lower positioning notch 112, and the push block 23 is ejected upwards so as to drive the hollow needle head 4 to move upwards. Then the cork stopper 5 is stopped by the seal cover 3 and thereby, it will separate from the cork stopper 5 directly. It is needless to hold the cork stopper 5 by one hand and thus the hand will not be hurt. When the hollow needle head 4 separates from the cork stopper, the hollow needle head 4 also moves to the topmost of the refrigerant can container 1. Then the push block 23 is pushed to pass through the upper limiting nose 1111 of the limiting rod 22 to enter into the upper positioning notch 111. Then the upper positioning notch 111 is limited by the upper limiting nose 1111. Then the hollow needle head 4 is stored safety. Then the cork stopper 5 can be taken down so as not to hurt anybody.

Thereby, in the present invention, the hollow needle head is made to be telescopic for use and storage. The user is unnecessary to touch the hollow needle head. Thereby, it can be used conveniently and safely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A safe cork removing device for wine bottles comprising a hollow needle head, a refrigerant can container, a sliding block and a seal cover, wherein the hollow needle head is capable of being inserted into a cork stopper sealing a wine bottle, a refrigerant can is placed in a refrigerant can container, by extruding the refrigerant can, the refrigerant will flow into the wine bottle, by the pressure of the refrigerant, the cork stopper separates from the wine bottle; characterized in that:
the refrigerant can container has a longitudinal sliding groove formed at a lateral side thereof; a lower end of the refrigerant can container has an opening; an upper and a lower lateral ends of the longitudinal sliding groove are formed with an upper positioning notch and a lower positioning notch, respectively;
the sliding block has a screw hole at a center thereof for locking a hollow needle head; a limiting rod extends from a lateral side of the sliding block; a push block is formed at an outer end of the limiting rod;
the seal cover is used to seal a lower end of the refrigerant can container; then it is welded by supersonic welding and the notch of the longitudinal sliding groove is also sealed so that the sliding block will not fall out;
wherein the sliding block is installed in the refrigerant can container from the opening of refrigerant can container; the limiting rod is exactly positioned in the longitudinal sliding groove and the push block is positioned at an outer side of the refrigerant can container; the sliding block is capable of moving along the longitudinal sliding groove by operating the limiting rod; by the upper positioning notch and lower positioning notch at two ends of the longitudinal sliding groove, when the push block is pushed toward one of the upper and lower positioning notches, the limiting rod will slide into one of the upper and lower positioning notches and then stop therein.

2. The safe cork removing device for wine bottles as claimed in claim 1, wherein at the connection portion of the upper positioning notch and the longitudinal sliding groove has an upper limiting nose and at the connection of the lower positioning notch and the longitudinal sliding groove has a lower limiting nose; when the push block is pushed toward one of the upper and lower positioning notches, the limiting rod will press respective one of the upper and lower positioning noses so as to slide into respective one of the upper and lower positioning notches and then stop therein, thereby, the sliding block being prevented from releasing.
